(19) United States
(12) Patent Application Publication
(10) Pub. No.: US 2018/0032555 A1
(43) Pub. Date: Feb. 1, 2018

(54) OBJECT DATABASE SYSTEM INCLUDING AN OBJECT-SPECIFIC HISTORICAL ATTRIBUTE-CHANGE INFORMATION SYSTEM

(71) Applicant: Bank of America Corporation, Charlotte, NC (US)

(72) Inventors: Ben Harrison, New York, NY (US); Mathew Hostetter, Greenwich, CT (US)

(21) Appl. No.: 15/221,688

(22) Filed: Jul. 28, 2016

(51) Int. Cl. G06F 17/30

(52) U.S. Cl. CPC G06F 17/30309; G06F 17/30607

(57) ABSTRACT

An object database system is provided. The system may include a plurality of objects. Each object may include a historical attribute-change information system. At least one parameter of the historical attribute-change information system may be determined relative to a transaction-history-identification level. The transaction-history-identification level may be based at least in part on a plurality of database transaction that occurred within the object database system. The transaction-history-identification level may correspond to a date/time value. Each object in the plurality of objects may be stored in a universal file format. The object database system may also include a cache memory and a disk memory. The object database system may be configured to utilize the cache memory in a targeted method. The targeted method may include explicit memory management of the disk memory.

### FIELD OF THE INVENTION

This invention relates to object database systems.

### BACKGROUND OF THE INVENTION

At times, database users require historical information regarding a database. Conventional databases have only been able to present historical data within specified windows of time. It would be desirable to recreate a database at any specific historical point in time.

### SUMMARY OF THE DISCLOSURE

An object database system is provided. The object database system may include a plurality of objects. Each object included in the object database system may include a historical attribute-change information system. At least one parameter of the historical attribute-change information system may be determined relative to a transaction-history-identification level.

The transaction-history-identification level may be based at least in part on a plurality of database transaction that occurred within the object database system. In some embodiments, the transaction-history-identification level may correspond to a date/time value.

Each object included in the plurality of objects may be stored in a universal file format. The universal file format may enable the system to manipulate the objects in a universal method. This may simplify the system, and, therefore, reduce the time required for manipulation of the objects.

In certain embodiments, the object database system may also include a cache memory and a disk memory. The object database system may be configured to utilize the cache memory in a targeted method. Utilizing the cache memory in a targeted method may ensure that the cache memory is utilized efficiently. The targeted method may include explicit memory management.

Explicit memory management, according to certain embodiments, may include directing each object to a specific section in both disk memory and cache memory. The system may set aside a specific section in disk memory for each object or group of objects. An object that requires manipulation by a CPU (“Central Processing Unit”), may be copied and/or transferred to a specific section in cache memory. The object may be manipulated while resident in cache memory. The manipulated object may then be directed from cache memory to a specific section in disk memory.

Because the database system directly controls the contents of both the cache memory and the disk memory, explicit memory management may eliminate the need for virtual memory management, paging techniques and/or any other software or hardware mechanism that act as an intermediary between the cache memory and the disk memory.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram according to certain embodiments;

FIG. 2 shows another illustrative diagram according to certain embodiments;

FIG. 3 shows yet another illustrative diagram according to certain embodiments;

FIG. 4 shows an illustrative memory architecture according to certain embodiments; and

FIG. 5 shows another illustrative memory architecture according to certain embodiments.

### DETAILED DESCRIPTION OF THE DISCLOSURE

An object database system is provided. The object database system may include a plurality of objects. Some examples of objects may include users of the database system, groupings of the users, how the users are grouped together, metadata about the users and/or security of database system. In some instances, the users may be grouped by line of business (“LOB”). In other instances, users may be grouped by age, length of employment, address, employment location or any other suitable grouping.

Other examples of objects may include trades, counterparties, clients, trades with global markets, financial terms between two parties, internal books and records, counterparties books and records, identity of counterpart(ies), information relating to internal books—i.e., which trader owns which books—and ecosystem of global markets.

Yet other examples of objects may include source code that enables the database to operate, records of the source code and records of when the source code was transmitted, referred to colloquially as “pushed”, to a repository.

Objects included in the database may be created, updated, deleted and/or renamed by one of the plurality of users of the database. Objects may also be added by one of the plurality of users of the database.

At times, one user (a writer) may open an object to manipulate the object and another user (a reader) may open the same object to read the object. Previously, if the object was already open, the reader, or any other suitable user, may be blocked from reviewing the object. Therefore, the object database system includes a multi-version concurrency control feature that allows the reader to review the object in a frozen state—i.e., the latest version of the object up until, and not including, the current writer's changes. When the writer completes the manipulation of the object, the reader may view the current version of the object. The reader may receive a notification, while reviewing the object, that a more current version is available.

At times, the system may perform conflict resolution. This may refer to rectifying an inconsistency caused when two changes happen to the same object in different database instances, and both changes are optimistically accepted by the associated instance. During replication, the inconsistency may be detected, and retroactively, one of the changes may be reverted.

At times, one user changes an object in one way and another user changes the same object in another manner. In order to prevent a probable inconsistency, the system may cause one of the two changes to fail.

Each time an object is created, updated, deleted and/or renamed (hereinafter, referred to collectively as “updated”), the updating act may be marked with an identification number. The identification number may be a transaction identification number associated with the updating. The transaction identification number may be a date time value. The transaction identification number may also be a transaction-history-identification level. Each transaction may include more than one updating act that occurred in more than one object.

Each object may maintain its own information regarding when it was updated. Each object may also hold its own previous versions. This feature may enable a user to acquire retroactive access to objects that have been updated.

In some embodiments, the transaction identification number may be a date/time value. In these embodiments, for example, object A may have a version from 11:00 am until 3:00 pm, a version from 3:00 pm until 4:00 pm, and a current version from 4:00 pm until the current time. In this example the changes may have occurred to the object at 11:00 am, 3:00 pm and 4:00 pm.

Another example may be object X may have a version from 2:00 pm until 3:00 pm and a current version from 6:00 pm until the current time. In this example, object X may have been deleted at 3:00 pm and then recreated at 6:00 pm.

This system may improve on typical object indexes. This system can query, at the object level history, into an object during at a certain time, during a specific time period or within a certain transaction bracket. For example, the system can inform which objects were labeled yellow at 5:45 pm. The system may also inform which objects were labeled as of or just after the 200^{th} transaction. Yet another example may be the system can inform which objects were labeled yellow between 6:00 pm and 12:00 pm yesterday. In still another example, the system can inform which objects were labeled yellow between the 300^{th} and 350^{th} transactions.

In some embodiments, the database system may remove previous versions as they become obsolete. In each embodiment, obsolete may have a different meaning. In some embodiments, after a certain number of transactions, the beginning transactions become obsolete and they are rewritten in a circular fashion. In other embodiments, the transactions become obsolete after a certain length of time.

The system may also enable preservation of the object information even after it is has become obsolete within the object level history. This preservation may include snapshots and journaling, as explained in more detail below.

Snapshots may include saving the entire system to disk. After a specific amount of time, for example, every minute, every two minutes, every thirty minutes, etc., the system may save the entire system, including all of the objects, and transmit the saved snapshot to disk. The disk may be local to the system. The disk may be remote to the system. Snapshots of the system may ensure that the system is durable and can be recreated in case of a disaster.

A snapshot (or checkpoint) may represent the entire state of the database system as of the moment the snapshot was initiated—e.g., at a pre-interruption moment. By definition, any journals from before the snapshot was initiated may be safely archived when the snapshot is complete. In a crash recovery, the journals created after the snapshot initiation may then be replayed into the database system to rectify the database system which experienced the interruption moment.

Journaling the system may include preserving actual transactions which modified the object by transcribing them into a journal. Each transaction may include the user who performed the transaction. Users can then apply the journal to a backup of the snapshot.

It should be appreciated that the system does not necessarily require journals to be replayed on a regular basis. For example, when an exemplary snapshot started at 2:00 pm and finished at 2:01 pm, any journals from before 2:00 pm may be discarded. Then, in this exemplary situation, the system crashes as of 2:05 pm. When the system restarts, it may load the snapshot which was started at 2:00 pm. The system may then replay the journal(s) from 2:00 pm onwards.

It should also be appreciated that the journal(s) may be implemented as a series of separate files. A new journal file may be created at each snapshot initiation, in order that once a snapshot completes, the system can easily archive the journal file(s) from before the snapshot initiation.

In addition to crash recovery, a snapshot can also be backed up to long term storage—e.g., a disaster recovery station—to support disaster recovery—e.g., catastrophic disk corruption (or interruption). Therefore, a user can examine any object from preferably any point in time up to and including the creation of the most recent backup.

Each journal may be saved from the moment of the last-in-time snapshot. This may allow a user to reconstruct the state of all objects as of any time after the snapshot. One can recover any snapshot and then replay the archived journals after the backup; thereby, restoring the state of the database to any moment after the snapshot was initiated.

As an example, if the system maintains a transaction-history-identification level for each object for a week, and a snapshot is backed up once a week, then the transaction-history-identification level would give database access to a user up to the creation time of the most recent backup without needing to save journals or execute daily backups. The use of the transaction-history-identification level may reduce the frequency of required backups.

The journal may include object-level history. The system may concurrently perform the transaction and journal the transaction. This may be an improvement over previous systems which only journaled the transaction after performing the transaction. The concurrency may also include acknowledging receipt of transaction—i.e., informing users that the transaction was performed—milliseconds before the transaction was actually performed. The prior acknowledgement may enable the system to operate in a faster and more efficient manner.

A transaction history is a mechanism that enables querying details of any receipt transaction, even if the journal containing the transaction has been deleted. Although conventionally, a journal may be used to provide this querying mechanism, the described system preferably utilizes a transaction history.

Usage of the transaction history may comprise a fraction of information (e.g., less than 1% of previous database systems), and therefore, a fraction of memory, as compared to previous systems. Even so, this fraction of information can be used to reconstitute the original transactions. For example, previously a system saved “transaction X modified object Y with data Z”. The transaction history saves “transaction X modified object Y” because “data Z” can be recovered by querying the system, via the transaction-history-identification level, as to what “object Y” looked like just prior to “transaction X”.

The system may include at least two types of memory—cache memory and disk memory. The cache memory is substantially faster and more costly with respect to available system resources such as local memory, and therefore, it is important to use the cache memory in connection with the disk memory in an efficient and timely manner. Therefore, the system may include a universal file format.

Although each file originates in cache memory, the universal file format may preferably be designed to stay on disk memory and be drawn into cache memory as needed. The universal file format eliminates the need for a substantial conversion between the disk memory and the cache memory. The universal file format also enables explicit memory management of the cache memory and the disk memory. Because the system knows the size and space of the file format of each object, the system can direct each object to a specific location in disk memory, and, when needed, to cache memory.

Although the universal file format may eliminate the need for a substantial conversion between the disk memory and the cache memory, the universal file format may include two versions—a compressed version and an uncompressed version of B+ tree nodes. Each version of any object may be stored as the value in a B+ tree whose key is the 3-tuple of the object path, when it became valid and if applicable, when it became invalid. A B+ tree may be an n-ary tree with a variable number of children per node. A B+ tree typically has a large number of children per node. A B+ tree may include a root, leaves and internal nodes. The root may be a leaf. B+ trees may contain sorted key/value pairs distributed amongst leaf nodes with inner nodes used to find the leaf node containing a given key.

A B+ tree may be valuable for storing data for efficient retrieval in a block-oriented storage systems. This may be because B+ trees may have a high fanout—i.e., the number of pointers to child nodes in a node. A B+ tree fanout may be as large as one hundred or more. The large fanout reduces the number of I/O operation required to locate an element on the tree.

A snapshot of objects on disk may comprise a set of B+ trees. Each B+ tree may include compressed versions of the nodes of those trees, a lookup table used to map from the node identifier to the compressed node on disk and a small amount of metadata.

The universal file format of each node may be fully contained in one file of the database system. The uncompressed version of a node may be resident on the cache memory. The system may convert between the compressed version of a node and the uncompressed version of a node as the objects are pulled into cache memory from disk memory and the objects are pushed into disk memory from cache memory.

The system may make heavy use of asynchronous I/O. A thread in the system may not wait for a task to be complete. Limiting the waiting performed by threads in the system causes the system to operate in a more efficient manner than typical systems. For example, a thread during the processing of a task may require data from disk memory. Instead of waiting for the data to be pulled into cache memory, the thread may ask the operating system to pull the data. In the meantime, the thread may work on another task. Meanwhile, when the paging is complete, an available thread, which may possibly be a different thread from the requesting thread, will be asked to resume the task now that the data became available.

The system may also include trickling. Trickling may include hyper-optimizing memory management while at a snapshot. Trickling may include optimistically writing information to disk which would probably need to be written to disk during the next snapshot, thereby enabling the next snapshot to be completed quicker. Many times, the objects or information written to disk may be the objects or information which were updated the least recently.

A method for creating and managing an object database system is provided. The method may include receiving a plurality of objects. Each object may include a historical attribute-change information system. The historical attribute-change information system may keep track of each attribute included in each object and when and how the attributes were updated.

The historical attribute-change information system may include parameters. At least one parameter of the historical attribute-change information system may be determined relative to a transaction-history-identification level. A transaction-history-identification level may be based at least in part on a plurality of database transactions that occurred within the object database system.

In some embodiments, the transaction-history-identification level may correspond to a date/time value. Each object may be stored in a universal file format.

The method may also include utilizing a disk memory. The method may also include managing a cache memory in connection with the disk memory in an explicit fashion.

Managing the cache memory in connection with the disk memory may include defining segments of information included within the plurality of objects. Managing the memory may also include specifying statements of locations in disk memory where each B+ tree node, or otherwise referred to as segment of information, should be stored. Managing the memory may also include retrieving at least one segment of information from the disk memory. Managing the information may also include placing the at least one segment of information into the cache memory at an explicitly specified location. Managing the memory may also include utilizing and/or manipulating the at least one segment of information in the cache memory. Managing the memory may include re-placing the at least one segment of information into the location in disk memory.

In some embodiments, each segment of information may hold one or more objects.

In some embodiments, managing the cache memory in connection with the disk memory occurs independent of virtual memory management techniques and/or paging memory management techniques. Virtual memory management techniques may include utilizing a table or other suitable medium or interface to go between the cache memory and the disk memory. Virtual memory management may enable the computer to simulate of more cache memory than the actual amount of cache memory. Paging memory management techniques may include utilizing a paging table to interface between the cache memory and the disk memory.

The universal file format may include a compressed version header and a BLOB while the object or memory segment is resident on disk memory. The method may include converting, upon retrieval of the object from disk memory to cache memory, the object into the universal file format that comprises an uncompressed version header and a B+ tree. When the object is resident on the cache memory, the universal file format of each node may include an uncompressed version header and a B+ tree. The method may further include converting, prior to re-placement of the object from cache memory to disk memory, the object into the universal file format of each node that comprises a compressed version header and a BLOB.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

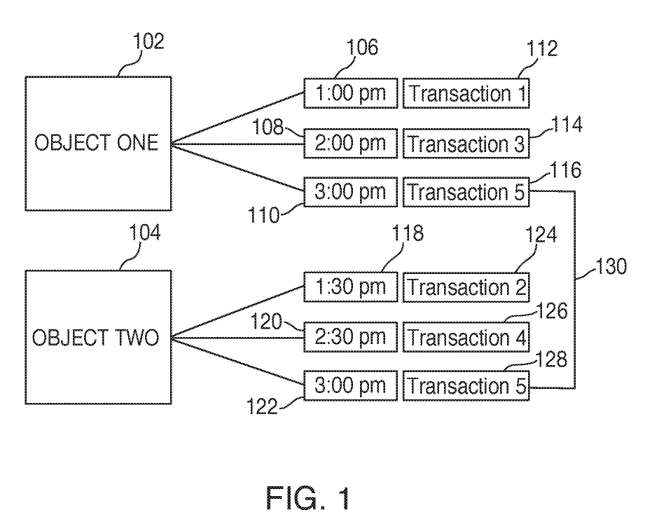

FIG. 1 shows an illustrative object diagram. Object one 102 may have been updated at 1:00 pm, as shown at 106, at 2:00 pm, as shown at 108 and at 3:00 pm, as shown at 110. The 1:00 pm change may be labeled transaction 1, as shown at 112. The 2:00 pm change may be labeled transaction 3, as shown at 114. The 3:00 pm change may be labeled transaction 5, as shown at 116. Object two 104 may have been updated at 1:30 pm, as shown at 118, 2:30 pm, as shown at 120 and 3:00 pm, as shown at 122. The 1:30 pm change may be labeled transaction 2, as shown at 124. Transaction 2 may occur between transaction 1 and transaction 3. The 2:30 pm change may be labeled transaction 4, as shown at 126. Transaction 4 may occur between transaction 3 and transaction 5. The 3:00 pm change may be labeled transaction 5, as shown at 128.

Lead line 130 shows that both changes occurred during the same transaction—i.e., transaction 5—at the same time—i.e., 3:00 pm.

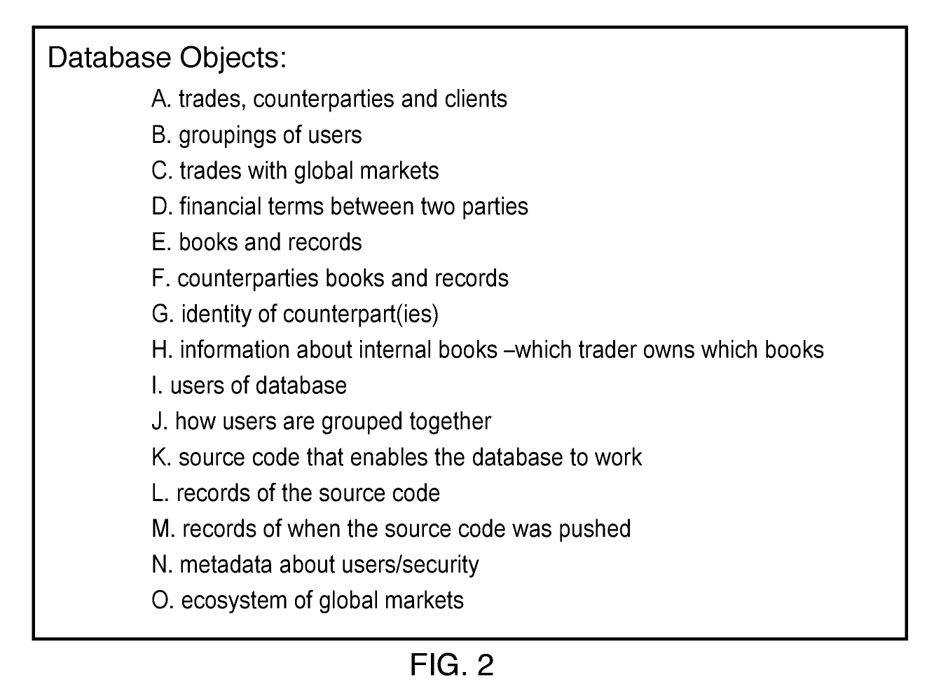

FIG. 2 shows an illustrative list of database objects. The database objects may include trades, counterparties and clients. The database objects may also include groupings of users. The database objects may also include trades with global markets. The database objects may also include financial terms between two parties. The database objects may also include books and records. The database objects may also include counterparties books and records. The database objects may also include identities of counterparties. The database objects may also include information about internal books—i.e., which trader owns which books. The database objects may also include users of database. The database objects may also include how users are grouped together. The database objects may also include source code that enables the database to work. The database objects may also include records of the source code. The database objects may also include records of when the source code was pushed. The database objects may also include metadata about users/security. The database objects may also include ecosystem of global markets.

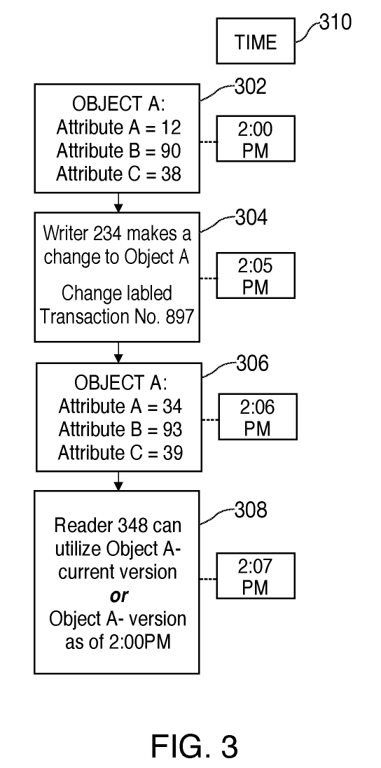

FIG. 3 shows an illustrative diagram. At 302, object A may include attributes A=12, B=90 and C=38. The time, shown in column 310, associated with 302 may be 2:00 pm. At 2:05 pm, shown at 304, writer 234 may make a change to object A. The change may be labeled transaction no. 897. At 2:06 pm, following the change to object A, object A may include the following attributes, as shown at 306, A=34, B=93 and C=39. At 2:07 pm, reader 348 may utilize the current version of object A or the version of object A, as of 2:00 pm, as shown at 308.

It should be appreciated that many times, a minority of an object's attributes—e.g., only one or two attributes—may be updated in a transaction. Therefore, some of the attributes in the 2:07 pm version would remain the same as in the 2:00 pm version and some of attributes in the 2:07 pm version would be different when compared to the 2:00 pm version.

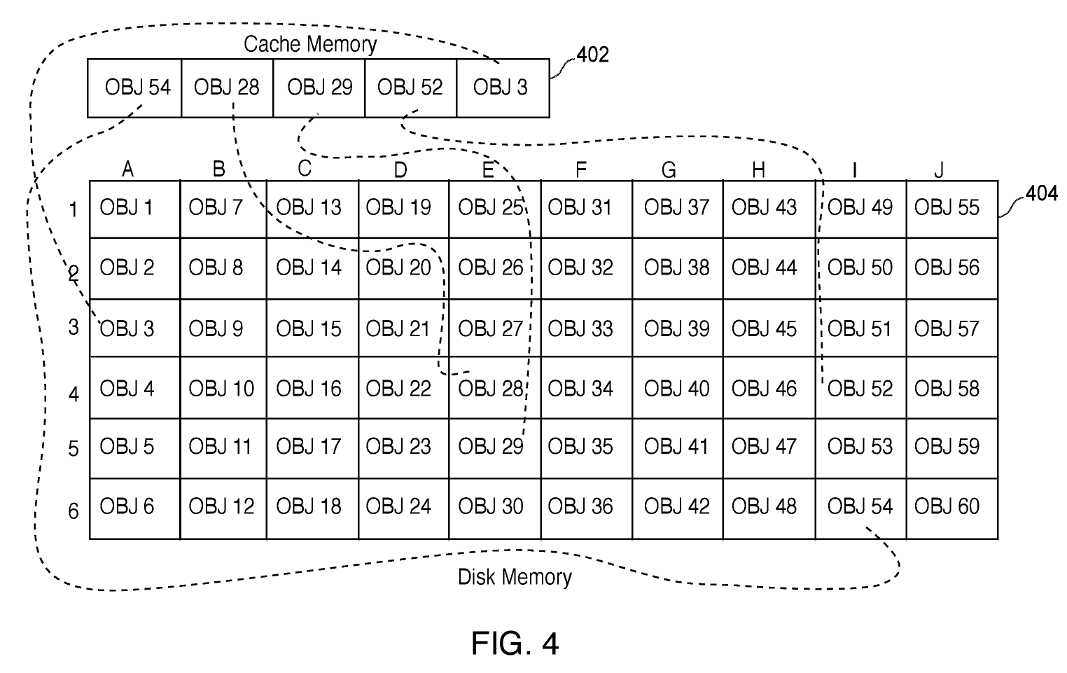

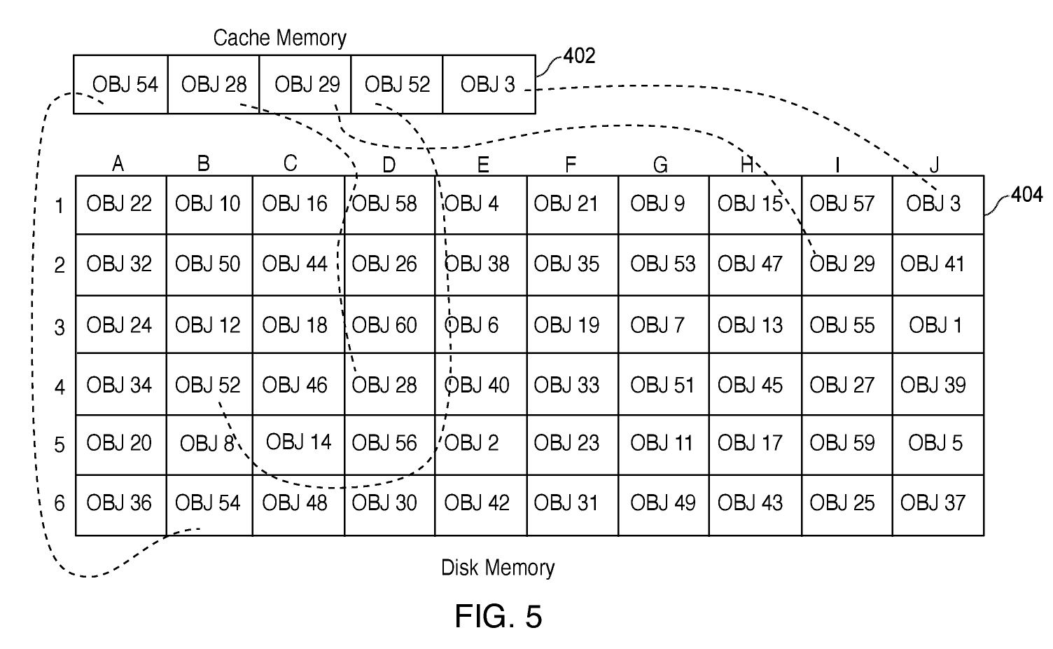

FIGS. 4 and 5 show explicit memory managing. Cache memory 402 may include five distinct locations. Disk memory 404 may include sixty distinct locations. The system may identify the locations of each object as positioned in disk memory. Therefore, the system may directly retrieve the objects from disk memory, manipulate the objects and place the objects back in disk memory. FIG. 4 shows the objects arranged in disk memory in numerical order. FIG. 5 shows the objects arranged in disk memory in random order. It may be irrelevant as to what order the objects are located in disk memory, as long as the system is aware where each object is located.

In some embodiments, an object is pulled from disk memory into cache memory to be updated. Upon completion of the object change, the object is put back in disk memory. The updated object may require more memory than when the object was first pulled from cache memory. This may be because the updated object holds both the old version of the object and the new version of the object. Therefore, the old location in disk memory may be too small for the new object. Accordingly, the explicit memory management system may place the object in a new location in disk memory that is large enough for the new object.

At times, the system may keep the old version of the object in the old location and save the updated object in a new location. The system may delete the old version of the object during a garbage collection or other suitable instruction.

At times, the system may place the new version of the object in a first new location and an old version of an object in a second new location. This may eliminate the need for a large portion of disk memory. The system may need to keep track of the location of each object and where the sections are located.

Thus, methods and apparatus for an object database system with an object-specific historical attribute-change information system is provided. Persons skilled in the art will appreciate that the present invention can be practiced by other than the described embodiments, which are presented for purposes of illustration rather than of limitation, and that the present invention is limited only by the claims that follow.

What is claimed is:

1. An object database system comprising:
a plurality of objects;
wherein:
each object comprises a historical attribute-change information system;
at least one parameter of the historical attribute-change information system is determined relative to a transaction-history-identification level; and
the transaction-history-identification level is based at least in part on a plurality of database transactions that occurred within the object database system.

2. The object database system of claim 1, wherein the transaction-history-identification level corresponds to a date/time value.

3. The object database system of claim 1, wherein each object included in the plurality of objects is stored in a universal file format.

4. The object database system of claim 3, wherein the object database system further comprises:
a cache memory; and
a disk memory;
wherein the object database system is configured to utilize the cache memory in a targeted method, said targeted method comprising explicit memory management of the disk memory.

5. The object database system of claim 4, wherein the explicit memory management of the disk memory comprises:
definition of segments of information within the plurality of objects;
specific statements of locations in disk memory where each segment of information should be stored;
retrieval of at least one segment of information from the disk memory;
placement of the at least one segment of information into the cache memory at an explicitly specified location;
utilization and/or manipulation of the at least one segment of information in the cache memory; and
re-placement of the at least one segment of information into the location in disk memory.

6. The object database system of claim 5, wherein each segment of information corresponds to one object within the plurality of objects.

7. The object database system of claim 5, wherein the explicit memory management occurs independent of virtual memory management techniques.

8. The object database system of claim 5, wherein the explicit memory management occurs independent of paging techniques.

9. The object database system of claim 5, wherein:
when an object is resident on disk memory, the universal file format of a node comprises a compressed version header and a blob; and
when the object is resident on cache memory, the universal file format comprises an uncompressed version header and a B+ tree node.

10. The object database system of claim 8, wherein the system is configured to convert, upon retrieval of an object from disk memory to cache memory, the object into the universal file format that comprises an uncompressed version header and a B+ tree node.

11. The object database system of claim 8, wherein the system is further configured to convert, prior to re-placement of the object from cache memory to disk memory, the object into the universal file format of a node that comprises a compressed version header and a blob.

12. A method for creating and managing an object database system, the method comprising:
receiving a plurality of objects;
wherein:
each object comprises a historical attribute-change information system;
at least one parameter of the historical attribute-change information system is determined relative to a transaction-history-identification level;
the transaction-history-identification level is based at least in part on a plurality of database transactions that occurred within the object database system.

13. The method of claim 12, wherein the transaction-history-identification level corresponds to a date/time value.

14. The method of claim 12, wherein each object included in the plurality of objects is stored in a universal file format.

15. The method of claim 14, wherein the method further comprises:
utilizing a disk memory; and
managing a cache memory in connection with the disk memory in an explicit fashion.

16. The method of claim 15, wherein managing the cache memory in connection with the disk memory comprises:
defining segments of information included within the plurality objects;
specifying statements of locations in disk memory where each segment of information should be stored;
retrieving at least one segment of information from the disk memory;
placing the at least one segment of information into the cache memory at an explicitly specified location;
utilizing and/or manipulating the at least one segment of information in the cache memory; and
re-placing the at least one segment of information into the location in disk memory.

17. The method of claim 16, wherein each segment of information holds one object.

18. The method of claim 16, wherein managing the cache memory in connection with the disk memory occurs independent of virtual memory management techniques.

19. The method of claim 16, wherein managing the cache memory in connection with the disk memory occurs independent of paging techniques.

20. The method of claim 16, wherein:
when an object is resident on the disk memory, the universal file format of a node comprises a compressed version header and a blob; and
when the object is resident on the cache memory, the universal file format comprises an uncompressed version header and a B+ tree node.

21. The method of claim 20, further comprising:
converting, upon retrieval of an object from disk memory to cache memory, the object into the universal file format that comprises an uncompressed version header and a B+ tree node.

22. The method of claim 20, further comprising:
converting, prior to re-placement of the object from the cache memory to disk memory, the object into the universal file format of a node the comprises a compressed version header and a blob.
